(19) United States
(12) Patent Application Publication
(10) Pub. No.: US 2025/0323457 A1
(43) Pub. Date: Oct. 16, 2025

(54) SOCKET

(71) Applicant: LOTES CO., LTD, Keelung (TW)

(72) Inventor: Wen-Cong Zhang, Guangzhou (CN)

(21) Appl. No.: 19/023,921

(22) Filed: Jan. 16, 2025

(30) Foreign Application Priority Data
Apr. 10, 2024 (CN) 202410429357.5

(51) Int. Cl. H01R 13/627; H01R 13/10

(52) U.S. Cl. CPC H01R 13/6273; H01R 13/10

(57) ABSTRACT

A socket comprising a driving member includes a pushing portion and a limiting portion. The pushing portion moves backward along a guiding slot and away from a central axis of a shell, while the limiting portion pushes an abutting portion backward, thereby driving a sliding shell to move backward. The angle between the direction of movement of the pushing portion and the direction in which the limiting portion pushes the abutting portion is less than ninety degrees, resulting in reduced force dispersion, making it easier to move the sliding shell backward. Furthermore, the backward travel distance of the pushing portion is long, and the travel distance of the sliding shell driven backward by the limiting portion is also long, facilitating the movement of the locking member into the locking slot and achieving automatic shell retraction and locking.

### CROSS-REFERENCE TO RELATED PATENT APPLICATION

This non-provisional application claims priority to and the benefit of, pursuant to 35 U.S.C. § 119(a), patent application Serial No. CN202410429357.5 filed in China on Apr. 10, 2024. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to a socket, and more particularly to a socket capable of quick disassembly and quick connection with a plug.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

An existing type of plug and socket includes a protrusion provided on a plug shell, front-row steel balls and rear-row steel balls provided on the insertion end of a socket shell, and a connecting nut mounted on the outside of the socket shell. A spring is provided between the step on the inner wall of the connecting nut and the front end of the socket shell. A first oblique surface is provided on the front end of the inner wall of the connecting nut, and a second oblique surface is provided on the rear side surface of the protrusion, and a third oblique surface is provided on the front side surface of the protrusion. The top surface of the protrusion is flat. The accommodating slot for mounting the front-row steel balls has an inner wall of varying diameters, and the accommodating slot for mounting the rear-row steel balls has the same structure as the accommodating slot for the front-row steel balls. The front-row steel balls, also referred to as driving steel balls, primarily function to first push the connecting nut backward over a certain distance, ensuring that when the rear-row steel balls contact the second oblique surface of the protrusion, the front-row steel balls can simultaneously act on the first oblique surface of the connecting nut. At least one rear-row steel ball can cooperate with the socket shell and the plug shell to achieve locking, and at least one front-row steel ball can push the connecting nut backward over a certain distance.

The following issues exist in the above structure:

The front-row steel balls, serving as driving steel balls, move within the accommodating slot and push against the first oblique surface at the front end of the inner wall of the connecting nut, thereby driving the connecting nut to move backward. This causes the first oblique surface of the connecting nut to move backward to the radial position of the rear-row steel balls, facilitating the continued radial pushing of the first oblique surface of the connecting nut by the rear-row steel balls. However, since the front-row steel balls move radially within the accommodating slot, which is perpendicular to the direction of pushing the connecting nut, the thrust is dispersed during the pushing process, making the pushing effortful. The travel distance of pushing the connecting nut backward is short due to the radial movement of the front-row steel balls. Moreover, because the front-row steel balls and the rear-row steel balls need to push against the first oblique surface of the connecting nut in the radial direction, the short travel of the front-row steel balls makes it difficult for the first oblique surface to move backward sufficiently for the rear-row steel balls to push against it. Consequently, the first oblique surface of the connecting nut may not reach the proper position, causing jamming when the rear-row steel balls push against the first oblique surface the connecting nut.

Therefore, a heretofore unaddressed need to design a socket exists in the art to address the aforementioned deficiencies and inadequacies.

### SUMMARY

In view of the deficiencies of the background technology, the present invention is directed to a socket, in which the driving member includes a pushing portion and two limiting portions integrally connected to both ends of the pushing portion. The pushing portion moves backward and away from the central axis of the shell along a guide inclined groove, and the limiting portions push the abutting portions backward, thereby driving the sliding shell to move backward. The angle between the direction of movement of the pushing portion and the direction in which the abutting portion is pushed backward is less than ninety degrees, resulting in minimal thrust dispersion, allowing the sliding shell to move backward with ease. The backward movement of the limiting portions that push the abutting portions and drive the sliding shell achieves a long travel distance, enabling the locking members to move along the accommodating slots away from the central axis of the shell.

To achieve the foregoing objective, the present invention adopts the following technical solutions:

A socket is used to mate with a plug. The plug includes a protrusion and a locking slot, and the protrusion includes an oblique surface and a top surface connected to the oblique surface. The socket includes: a shell, wherein the shell defines a central axis mating with the plug, the shell includes an insertion cavity, a peripheral wall surrounding the insertion cavity, at least two guiding slots and a plurality of accommodating slots, the insertion cavity allows the plug to be inserted backward therein, each of the guiding slots and each of the accommodating slots run through the peripheral wall, the locking slot is located in front of the top surface, and the top surface is located in front of the oblique surface; a sliding shell, sleeved outside of the shell, wherein the sliding shell includes a plurality of abutting portions, a stopping portion and a groove located in front of the stopping portion; at least two driving members, wherein each of the driving members includes a pushing portion and two limiting portions integrally connected to two ends of the pushing portion, the pushing portion is accommodated in one of the two guiding slots, and the two limiting portions are located outside a same one of the guiding slots and in front of the two abutting portions; and a plurality of locking members, correspondingly accommodated in the accommodating slots respectively, wherein each of the locking members is located behind the pushing portion of each of the driving members; wherein prior to mating of the plug and the socket, the stopping portion abuts against the locking members, and the groove is located in front of the locking members; wherein during a mating process of the plug and the socket, the protrusion moves backward, the oblique surface abuts against the pushing portion, the pushing portion moves backward along the corresponding one of the guiding slots and away from the central axis, and each of the limiting portions pushes each of the abutting portions backward to drive the sliding shell to move backward until the pushing portion reaches the top surface of the protrusion, and at this time, the locking members are located in front of the stopping portion; wherein the protrusion continues to move backward, the oblique surface abuts against the locking members; the oblique surface pushes the locking members to move away from the central axis along the accommodating slots until the locking members reach the top surface of the protrusion, and at this time, the locking members are at least partially located within the groove; wherein the protrusion continues to move backward, the locking members are at least partially located within the locking slot, and at this time, the sliding shell returns forward and each of the abutting portions pushes each of the limiting portions forward, the pushing portion moves toward the central axis along the corresponding one of the guiding slots, the groove is located in front of the locking members, and the stopping portion abuts against the locking members in the locking slots to achieve locking.

In certain embodiments, the socket further includes an elastic member sleeved outside of the shell, wherein each of the guiding slots includes a front wall near the central axis, in a forward returning process of the sliding shell, the elastic member pushes the sliding shell to move forward, the pushing portion moves toward the central axis along the corresponding one of the guiding slots, the pushing portion abuts against and is stopped by the front wall, and at this time, the abutting portions is stopped by the limiting portions.

In certain embodiments, the sliding shell further includes a mounting cavity, a body surrounding the mounting cavity and a plurality of limiting slots concavely provided on an outer peripheral surface of the body, the abutting portions are rear walls of the limiting slots, the shell is accommodated in the mounting cavity, each of the limiting portions includes a first section connected to the pushing portion and a second section bending and extending backward from the first section, and an end of the second section away from the first section is fixed in a corresponding one of the limiting slots and abuts backward against a corresponding one of the abutting portions.

In certain embodiments, each of the limiting slots includes a fixing slot and a reserved slot located outside the fixing slot, the second section of each of the limiting portions includes an extending section connected to the first section and a buckling section extending from the extending section, the two buckling sections of a same one of the driving members bend and extend toward each other, the buckling section passes through the reserved slot to be fixed in the fixing slot, a gap exists between the buckling section and a slot wall of the reserved slot, the abutting portions are rear walls of the fixing slots of the limiting portions, and the buckling section abuts backward against the corresponding one of the abutting portions.

In certain embodiments, the pushing portion is located in front of the body, a gap exists between the first section and a front surface of the body, in the mating process of the plug and the socket, an end of the second section away from the first section serves as a pivotal point, the first section moves away from the central axis, the pushing portion moves away from the central axis along the corresponding one of the guiding slots, the sliding shell returns forward, the end of the second section away from the first section serves as the pivotal point, the first section moves toward the central axis, and the pushing portion moves toward the central axis along the corresponding one of the guiding slots.

In certain embodiments, the sliding shell further includes a mounting cavity and a body surrounding the mounting cavity, the shell is accommodated in the mounting cavity, the groove is concavely provided on an inner peripheral surface of the body, the groove includes a first circumferential surface and a first annular oblique surface connected forward to the first circumferential surface, the first circumferential surface is connected to a front surface of the body, the first annular oblique surface inclines backward toward the central axis, an outer peripheral surface of the peripheral wall includes a second circumferential surface and a second annular oblique surface connected forward to the second circumferential surface; the second annular oblique surface inclines backward toward the central axis, and in a forward returning process of the sliding shell, the second annular oblique surface is located directly in front of the first annular oblique surface to stop the first annular oblique surface from excessively moving forward.

In certain embodiments, the sliding shell further includes a mounting cavity and a body surrounding the mounting cavity, the shell is accommodated in the mounting cavity, the groove is concavely provided on an inner peripheral surface of the body, the groove includes a first circumferential surface and a first annular oblique surface connected forward to the first circumferential surface, the first circumferential surface is connected to a front surface of the body, the first annular oblique surface inclines backward toward the central axis and is connected backward to the stopping portion, the outer peripheral surface of the peripheral wall includes a second circumferential surface, the second circumferential surface is sleeved inside the first circumferential surface, and a first radial distance between the second circumferential surface and the first circumferential surface is less than a second radial distance between the second circumferential surface and the stopping portion.

In certain embodiments, the sliding shell further includes a mounting cavity and a body surrounding the mounting cavity, the shell is accommodated in the mounting cavity, the groove is concavely provided on an inner peripheral surface of the body, the groove includes a first circumferential surface and a first annular oblique surface connected forward to the first circumferential surface, a distance from the pushing portion to a corresponding one of the locking members in a front-rear direction is less than or equal to a length of the top surface of the protrusion, in a process of the oblique surface of the protrusion pushing the corresponding one of the locking members to move away from the central axis along the corresponding one of the accommodating slots, the pushing portion is located on the top surface of the protrusion, the sliding shell stops moving in the front-rear direction, the groove is located in a moving direction of the locking members, both the first circumferential surface and the first annular oblique surface maintain gaps with the locking member, and when the locking members are located at a rear portion of the top surface of the protrusion, the pushing portion is located at a front portion of the top surface of the protrusion, and the locking members are accommodated in the groove.

Compared with the prior art, the present invention has the following advantageous effects:

In the present invention, the driving members at the front and the locking members at the rear are provided. Each driving member includes a pushing portion and two limiting portions integrally connected to the two ends of the pushing portion. The pushing portion moves backward and away from the central axis of the shell along a guiding groove. The limiting portions push the abutting portions backward, thereby driving the sliding shell to move backward. Compared to case in the prior art where the front-row steel balls move radially, which is perpendicular to the direction of pushing the connecting nut, in the present invention, an angle between the moving direction of the pushing portion and the backward pushing direction of the abutting portion is less than 90 degrees, which results in minimal thrust dispersion, making it easier to push the sliding shell backward. In addition, the backward travel of the pushing portion is long, allowing the limiting portions to drive the sliding shell to move backward over a longer travel distance, which is conducive for the locking members to move away from the central axis of the shell along the accommodating slots, such that in the mating process of the plug and the socket, the sliding shell automatically retracts backward, and the plug and the socket are easily locked.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective view of a socket and a plug according toa first embodiment of the present invention before mating.

FIG. 2 is an exploded view of the socket according to the first embodiment of the present invention.

FIG. 3 is a partial enlarged view of FIG. 2 along a portion A.

FIG. 4 is a schematic view of the position of the driving member when the driving member abuts against the oblique surface of the protrusion according to the first embodiment of the present invention.

FIG. 5 is a schematic view of the position of the locking member when the driving member abuts against the oblique surface of the protrusion according to the first embodiment of the present invention.

FIG. 6 is a schematic view of the position of the driving member when the driving member abuts against the top surface of the protrusion according to the first embodiment of the present invention.

FIG. 7 is a schematic view of the position of the locking member when the driving member abuts against the top surface of the protrusion according to the first embodiment of the present invention.

FIG. 8 is a schematic view of the position of the driving member when the locking member abuts against the top surface of the protrusion according to the first embodiment of the present invention.

FIG. 9 is a schematic view of the position of the locking member when the locking member abuts against the top surface of the protrusion according to the first embodiment of the present invention.

FIG. 10 is a schematic view of the position of the driving member when the locking member enters the locking slot according to the first embodiment of the present invention.

FIG. 11 is a schematic view of the position of the locking member when the locking member enters the locking slot according to the first embodiment of the present invention.

FIG. 12 is a partial enlarged view of FIG. 4 along a portion B.

FIG. 13 is a schematic view of the position of the driving member when the driving member abuts against the rear side of the top surface of the protrusion according toa second embodiment of the present invention.

FIG. 14 is a schematic view of the position of the locking member when the driving member abuts against the rear side of the top surface of the protrusion according to the second embodiment of the present invention.

FIG. 15 is a schematic view of the position of the driving member when the driving member abuts against the front side of the top surface of the protrusion according to the second embodiment of the present invention.

FIG. 16 is a schematic view of the position of the locking member when the driving member abuts against the front side of the top surface of the protrusion according to the second embodiment of the present invention.

FIG. 17 is a partial enlarged view of FIG. 15 along a portion C.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

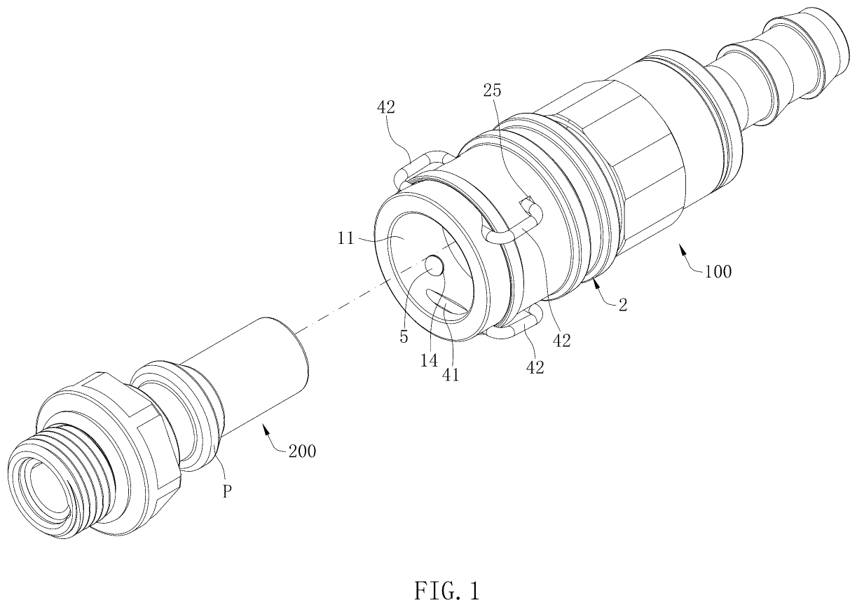

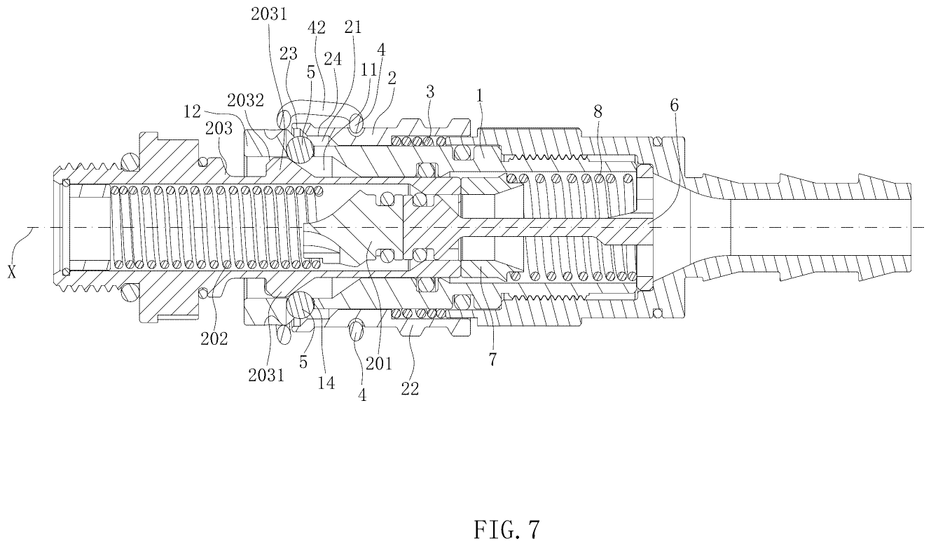

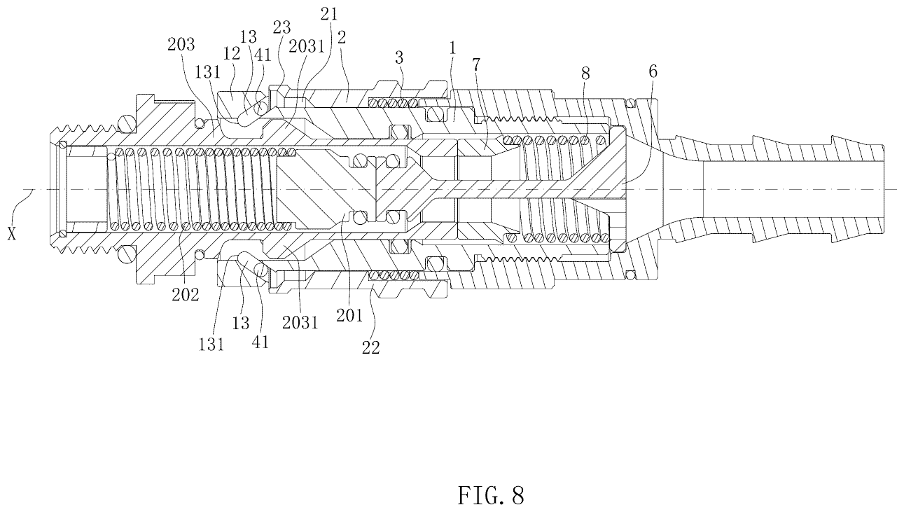

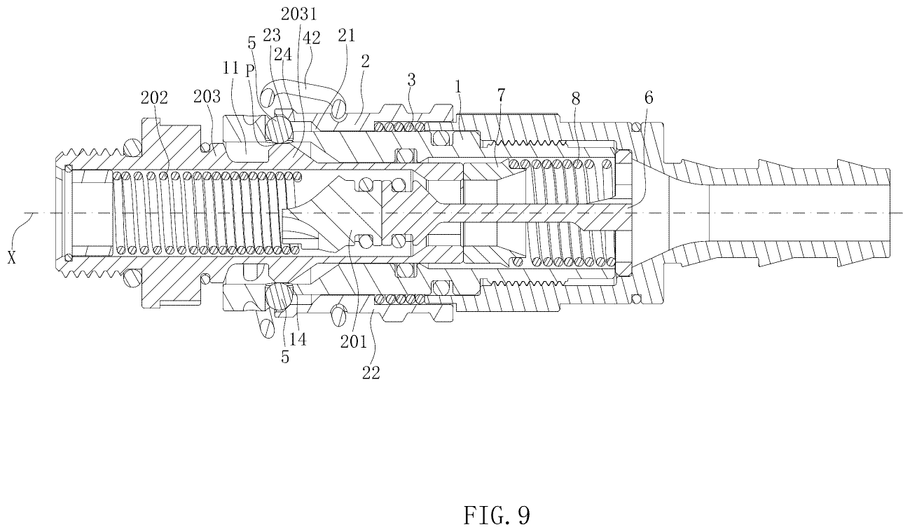

The description will be made as to the embodiments of the present invention in conjunction with the accompanying drawings in FIGS. 1-17. In accordance with the purposes of this invention, as embodied and broadly described herein, this invention, in one aspect, relates to a socket.

To better understand the purpose, structure, features, and effects of the present invention, the following explanation is provided in conjunction with the accompanying drawings and specific embodiments.

FIG. 1 to FIG. 12 show a socket 100 according to a first embodiment of the present invention. The socket 100 is used to mate with a plug 200 along the front-rear direction. The socket 100 includes a shell 1, a sliding shell 2 sleeved outside of the shell 1, an elastic member 3 sleeved outside of the shell 1, two driving members 4 assembled on the shell 1, and four locking members 5 assembled on the shell 1. The shell 1 defines a central axis X for mating with the plug 200, and a diameter direction of the shell 1 passing through the central axis X is defined as a radial direction. The driving members 4 are made of a metal material. In this embodiment, the driving members 4 are made of stainless steel. In other embodiments, the driving members 4 may be made of other metal materials. In other embodiments, the quantity of the driving members 4 may be 3, 4 or more. Similarly, in other embodiments, the quantity of the locking members 5 may be 3, 5, 6, 7, 8 or more. In this embodiment, the locking members 5 are steel balls. In other embodiments, the locking members 5 may be steel columns or other metal spheres or posts. The socket 100 further includes a socket valve core 6, a socket valve body 7 sleeved outside of the socket valve core 6, and a socket spring 8 abutting against the socket valve body 7.

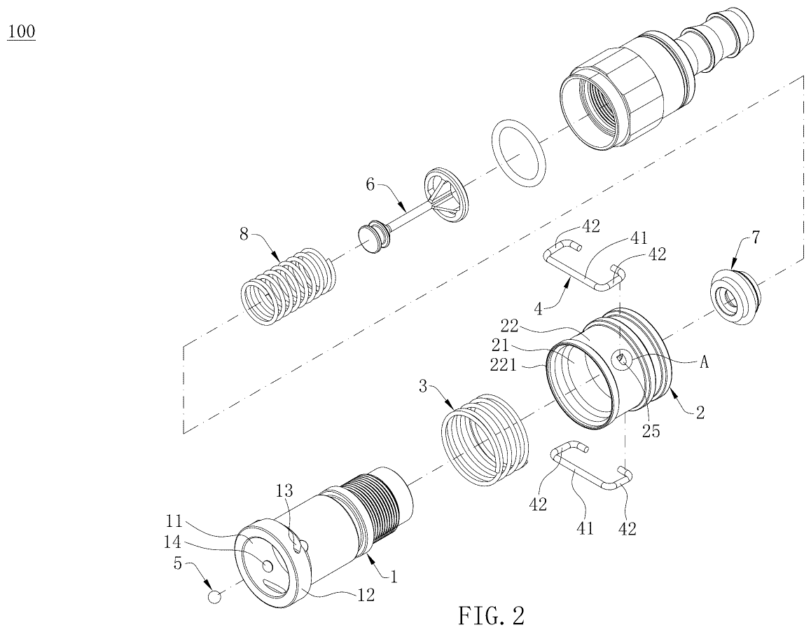

As shown in FIG. 2, the shell 1 includes an insertion cavity 11, a peripheral wall 12 surrounding the insertion cavity 11, two guiding slots 13 and four accommodating slots 14. In other embodiments, the quantity of guiding slots 13 may be 4, 6, 8 or more. The insertion cavity 11 allows the plug 200 to be inserted backward therein. Both the guiding slots 13 and the accommodating slots 14 run through the peripheral wall 12. The guiding slots 13 incline backward and away from the central axis X. The guiding slots 13 include a front wall 131 near the central axis X. The accommodating slots 14 run radially through the peripheral wall 12. Portions of the driving members 4 are accommodated in the guiding slots 13, and the quantity of driving members 4 corresponds to the quantity of guiding slots 13. The locking members 5 are located behind the pushing portions 41 and are accommodated in the accommodating slots 14. The quantity of locking members 5 corresponds to the quantity of accommodating slots 14. In other embodiments, the quantity of accommodating slots 14 may be 3, 5, 6, 7, 8 or more. The outer peripheral surface of the peripheral wall 12 includes a second circumferential surface 121 and a second annular oblique surface 122 connected forward to the second circumferential surface 121. The second annular oblique surface 122 inclines backward toward the central axis X.

As shown in FIG. 2, the sliding shell 2 includes a mounting cavity 21, a body 22 surrounding the mounting cavity 21, a groove 23 concavely provided on the inner peripheral surface of the body 22, a stopping portion 24 located behind the groove 23 and four limiting slots 25 concavely provided on the outer peripheral surface of the body 22. The shell 1 is accommodated in the mounting cavity 21.

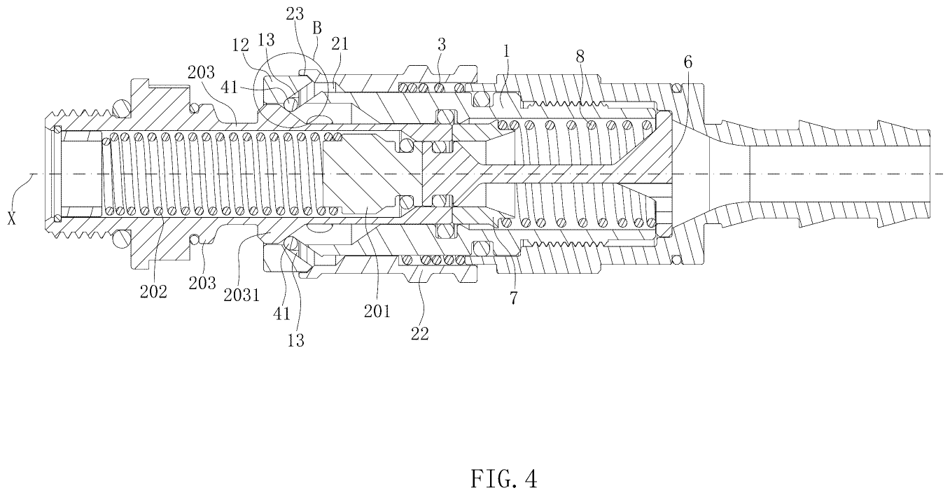

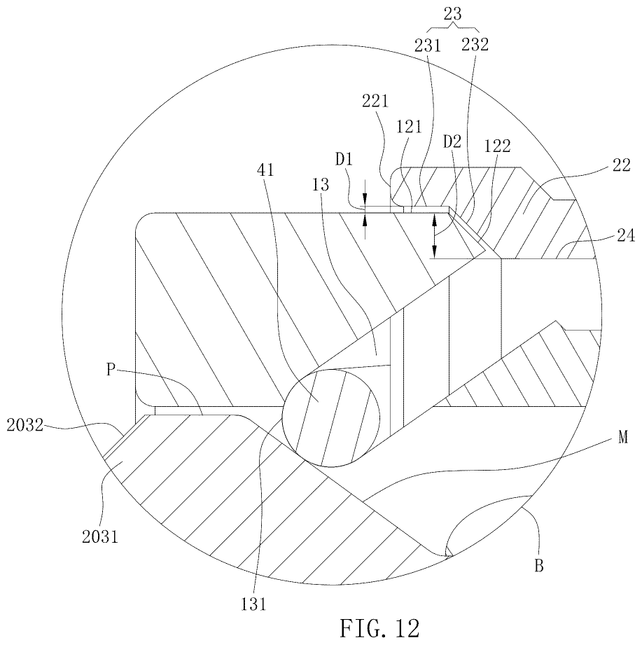

As shown in FIG. 4 and FIG. 12, the groove 23 includes a first circumferential surface 231 and a first annular oblique surface 232 connected forward to the first circumferential surface 231. The first circumferential surface 231 is connected to the front surface 221 of the body 22, and the first annular oblique surface 232 inclines backward toward the central axis X. The first annular oblique surface 232 is connected backward to the stopping portion 24. The second circumferential surface 121 is sleeved within the first circumferential surface 231, and a radial distance D1 between the second circumferential surface 121 and the first circumferential surface 231 is less than a radial distance D2 between the second circumferential surface 121 and the stopping portion 24. The radial distance D1 is defined as the difference between the radial distance of the first circumferential surface 231 from the central axis X and the radial distance of the second circumferential surface 121 from the central axis X. The radial distance D2 is defined as the difference between the radial distance of the second circumferential surface 121 from the central axis X and the radial distance of the stopping portion 24 from the central axis X. In the process of the sliding shell 2 returning forward, the second annular oblique surface 122 is located directly in front of the first annular oblique surface 232, preventing the first annular oblique surface 232 from excessively moving forward.

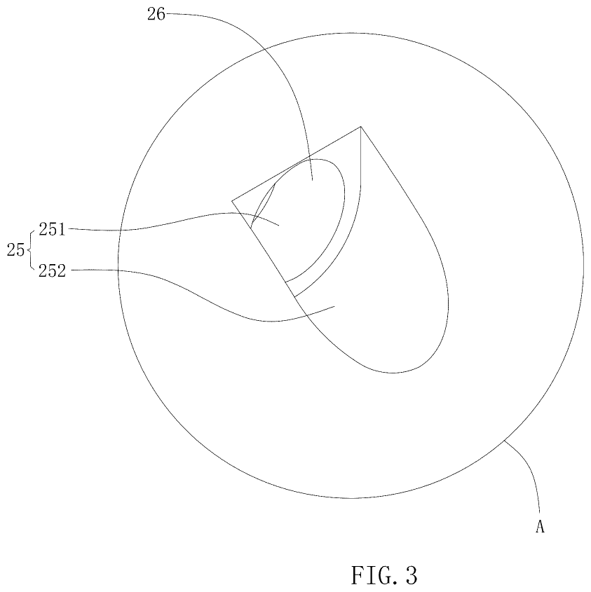

As shown in FIG. 2 and FIG. 3, each limiting slot 25 includes a fixing slot 251 and a reserved slot 252 positioned outside the fixing slot 251. The abutting portion 26 is the rear side wall of the fixing slot 251.

As shown in FIG. 1 and FIG. 2, each driving member 4 includes a pushing portion 41 and two limiting portions 42 integrally connected to two ends of the pushing portion 41. The pushing portion 41 is located in front of the body 22 and is accommodated in the guiding slot 13. The two limiting portions 42 are located outside the same guiding slot 13 and in front of the abutting portions 26.

As shown in FIG. 1 and FIG. 2, each limiting portion 42 includes a first section 421 connected to the pushing portion 41 and a second section 422 extending backward from the first section 421. Each second section 422 includes an extending section 4221 connected to the first section 421 and a buckling section 4222 extending from the extending section 4221. A gap exists between the first section 421 and the front surface 221 of the body 22. The two buckling sections 4222 of the same driving member 4 bend and extend toward each other, and the buckling sections 4222 pass through the reserved slots 252 to be fixed in the fixing slots 251. A gap exists between each buckling section 4222 and the slot wall of the corresponding reserved slot 252, and the buckling sections 4222 abut against the abutting portions 26. In the mating process of the plug 200 and the socket 100, the buckling section 4222 serving as a pivotal point, the first section 421 moves away from the central axis X, the pushing portion 41 moves away from the central axis X along the corresponding one of the guiding slots 13, and the sliding shell 2 returns forward. The buckling section 4222 serving as a pivotal point, the first section 421 moves toward the central axis X, and the pushing portion 41 moves toward the central axis X along the corresponding one of the guiding slots 13.

FIG. 4 to FIG. 12 show the plug 200 according to the present embodiment, which includes a plug valve core 201, a plug spring 202 abutting against the plug valve core 201 and a plug valve body 203 sleeved outside of the plug valve core 201. The plug valve body 203 is provided with a protrusion 2031 and a locking slot 2032 located in front of the protrusion 2031. The protrusion 2031 includes an oblique surface M and a top surface P connected to the oblique surface M.

As shown in FIG. 1 and FIG. 4, in this embodiment, the mating and locking of the plug 200 and the socket 100 are achieved by applying a thrust force to the plug 200 and the socket 100 in the front-rear direction. The specific moving process of the plug 200 and the socket 100 is described as follows.

As shown in FIG. 1, in an initial state, i.e., before the plug 200 and the socket 100 are mated, the pushing portion 41 abuts against and is stopped by the front wall 131 of the corresponding one of the guiding slot 13, the stopping portion 24 abuts against the locking member 5, the locking member 5 is accommodated in the corresponding one of the accommodating slot 14, and the groove 23 is located in front of the locking members 5.

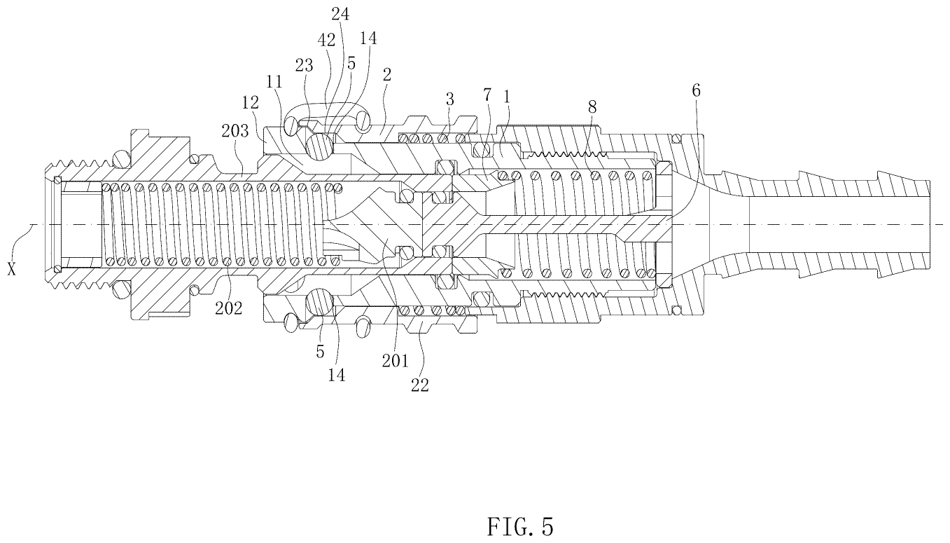

As shown in FIG. 4 to FIG. 5, when the plug 200 is inserted backward into the insertion cavity 11, the mating process of the plug 200 and the socket 100 begins. The protrusion 2031 moves backward, and the oblique surface M abuts against the pushing portion 41. The pushing portion 41 moves backward and away from the central axis X along the corresponding one of the guiding slot 13. Since the pushing portion 41 is integrally connected with the limiting portions 42, the limiting portions 42 connecting the two ends of the pushing portion 41 push the abutting portion 26 backward, thereby driving the sliding shell 2 to move backward until the pushing portion 41 reaches the top surface P of the protrusion 2031. At this time, the locking member 5 is located in front of the stopping portion 24, and the limiting portions 42 stop pushing the sliding shell 2 to move further backward.

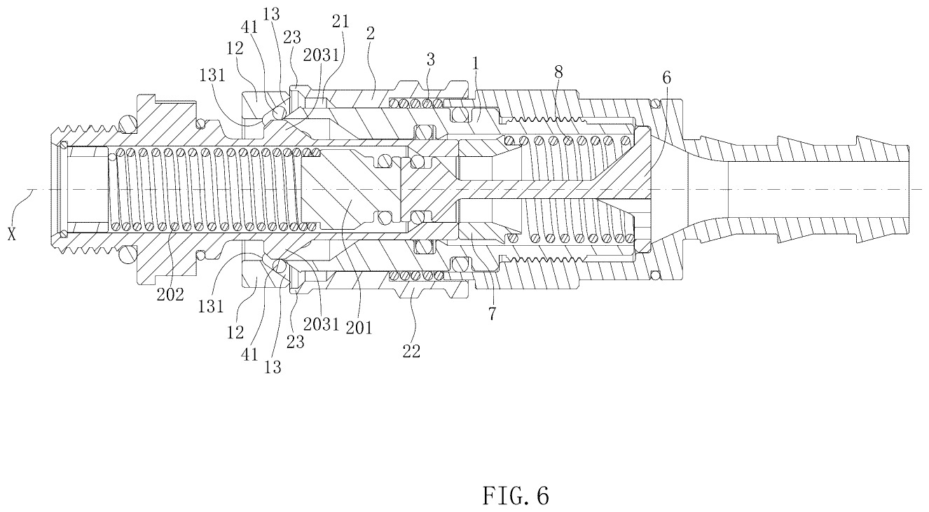

As shown in FIG. 6 to FIG. 9, the mating process of the plug 200 and the socket 100 continues. The protrusion 2031 moves backward, and the oblique surface M abuts against the locking member 5. The oblique surface M pushes the locking member 5 away from the central axis X along the corresponding one of the accommodating slots 14 until the locking member 5 reaches the top surface P of the protrusion 2031. In this process, the locking member 5 is at least partially located within the groove 23. The locking member 5 abuts against the first annular oblique surface 232, and the locking member 5 pushes the sliding shell 2 backward.

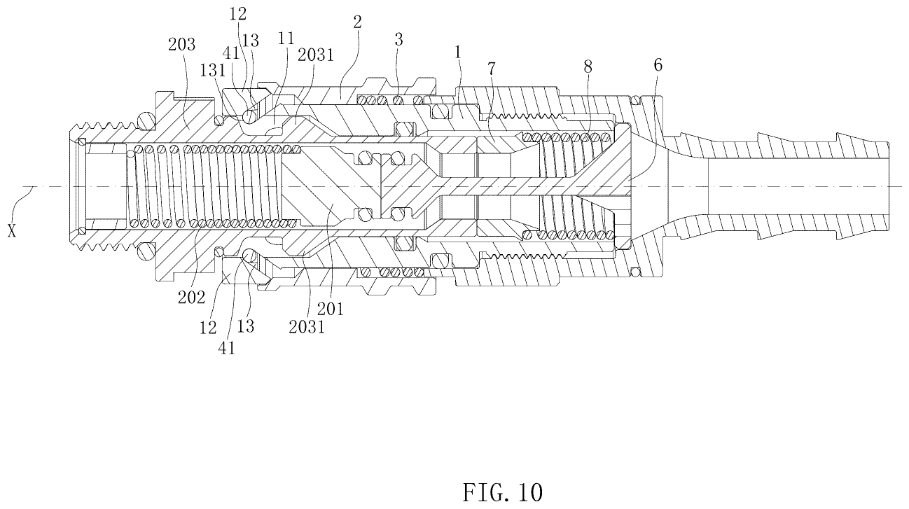

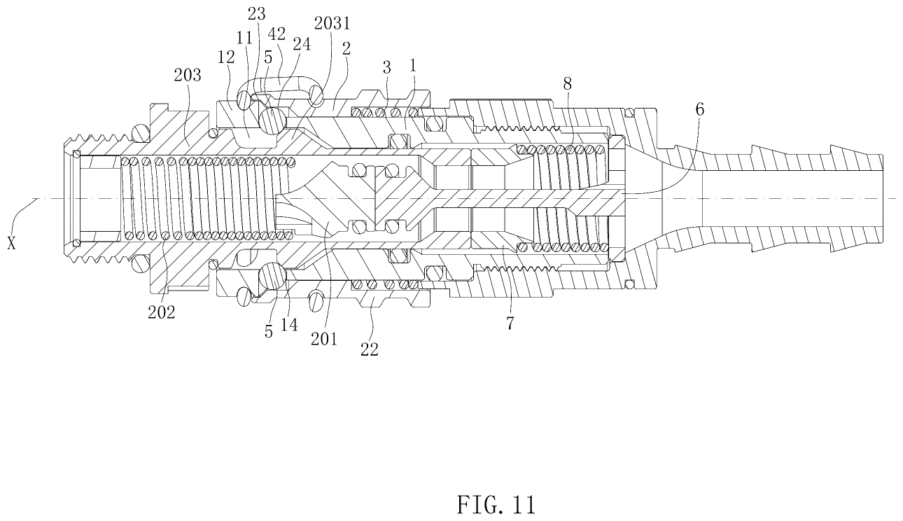

As shown in FIG. 10 to FIG. 11, the protrusion 2031 continues to move backward, and the locking member 5 is at least partially accommodated in the locking slot 2032. At this time, the elastic member 3 pushes the sliding shell 2 to return forward. The abutting portion 26 pushes the limiting portions 42 forward, and the pushing portion 41 moves toward the central axis X along the corresponding one of the guiding slot 13. The pushing portion 41 abuts against and is stopped by the front wall 131, thereby causing the abutting portion 26 to be stopped by the limiting portion 42. The groove 23 is located in front of the locking member 5, and the stopping portion 24 abuts against the locking member 5 in the locking slot 2032, thus facilitating the locking process.

In the unlocking process of the plug 200 and the socket 100, a thrust force is applied to the sliding shell 2 to push the sliding shell 2 backward. The sliding shell 2 drives the limiting portions 42 backward, and the limiting portions 42 drive the pushing portion 41 to move backward along the corresponding one of the guiding slot 13 and away from the central axis X. At this time, the stopping portion 24 is located behind the locking member 5. The protrusion 2031 moves forward, pushing the locking member 5 into the groove 23. The protrusion 2031 continues moving forward and exits. A gap exists between the protrusion 2031 and the pushing portion 41, and finally, the plug 200 exits the insertion cavity 11 of the shell 1 in a forward direction.

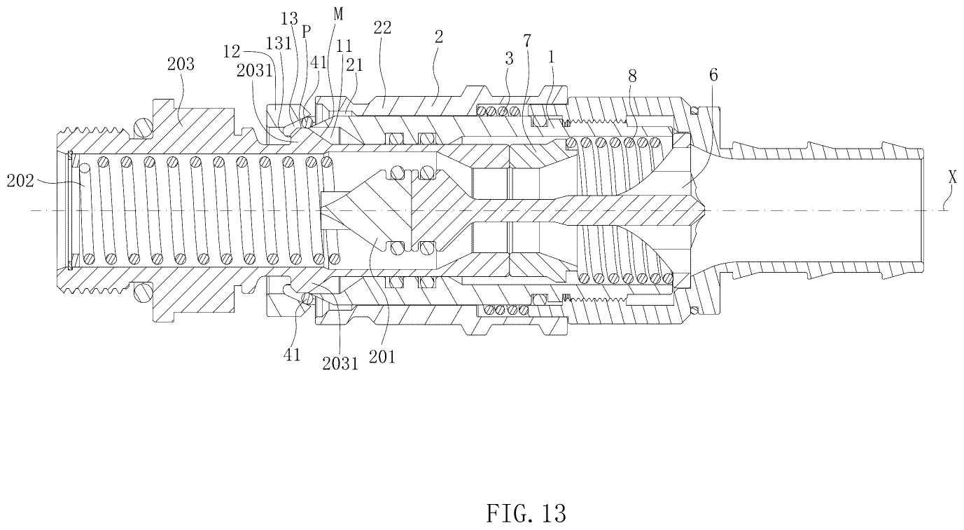

FIG. 13 to FIG. 17 show a socket 100 according to a second embodiment of the present invention, which is used to mate with a plug 200 along the front-rear direction. The difference between the structure in this embodiment and the first embodiment exists as follows.

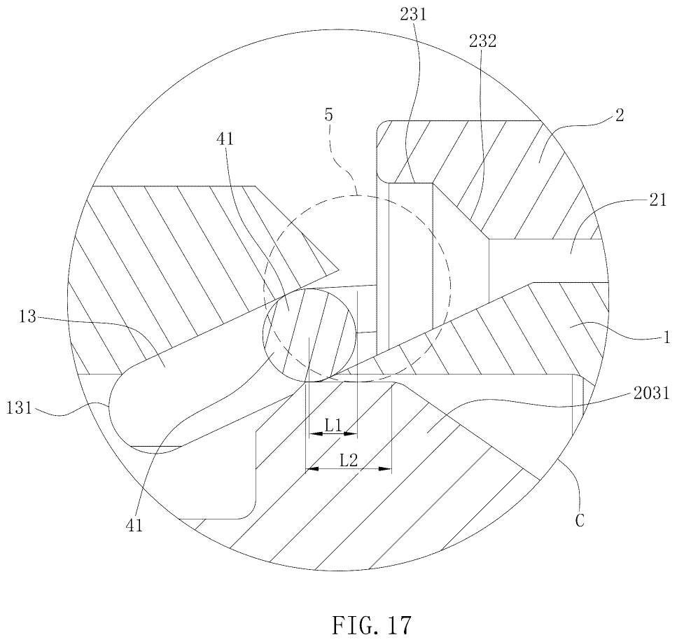

In this embodiment, as shown in FIG. 17, the central distance L1 between the pushing portion 41 and the locking member 5 along the front-rear direction is less than the length L2 of the top surface P of the protrusion 2031. To facilitate understanding of the central distance L1 between the pushing portion 41 and the locking member 5 along the front-rear direction, the locking member 5 is depicted in dashed lines on the top surface P of the protrusion 2031. In other embodiments, the distance L1 between the pushing portion 41 and the locking member 5 along the front-rear direction may be equal to the length of the top surface P of the protrusion 2031. Other structures are identical to those in the first embodiment, and are thus not reiterated herein.

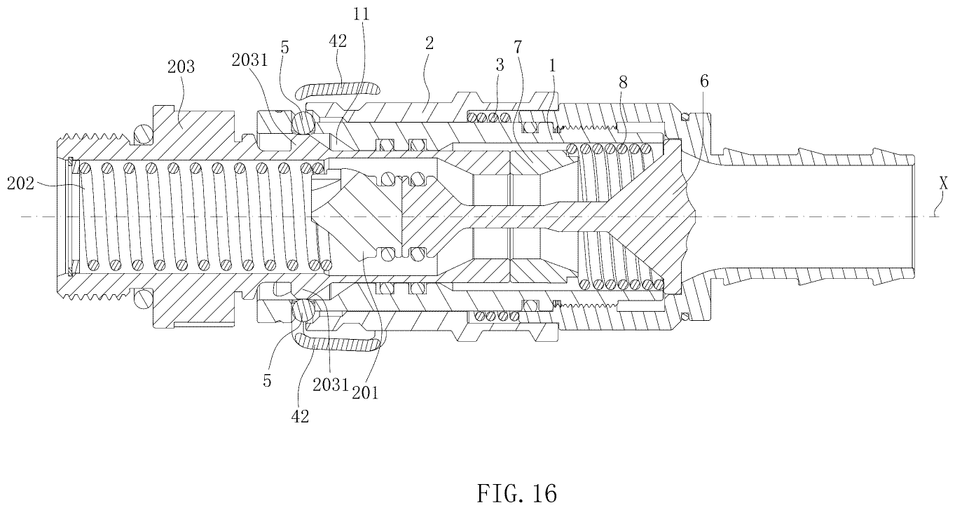

As shown in FIG. 13 and FIG. 16, in this embodiment, the mating and locking of the plug 200 and the socket 100 are achieved by applying the thrust force to the plug 200 and the socket 100 in the front-rear direction. The specific movement process differs from the process in the first embodiment as follows.

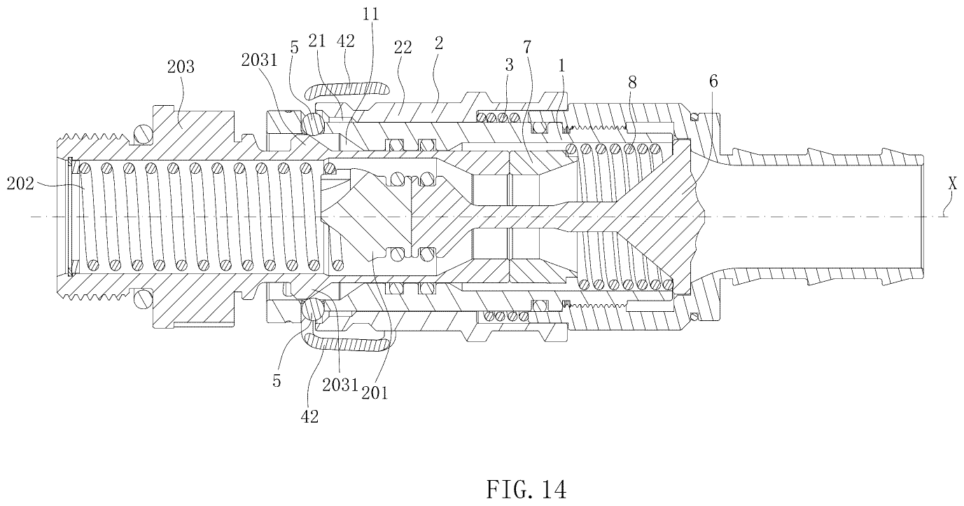

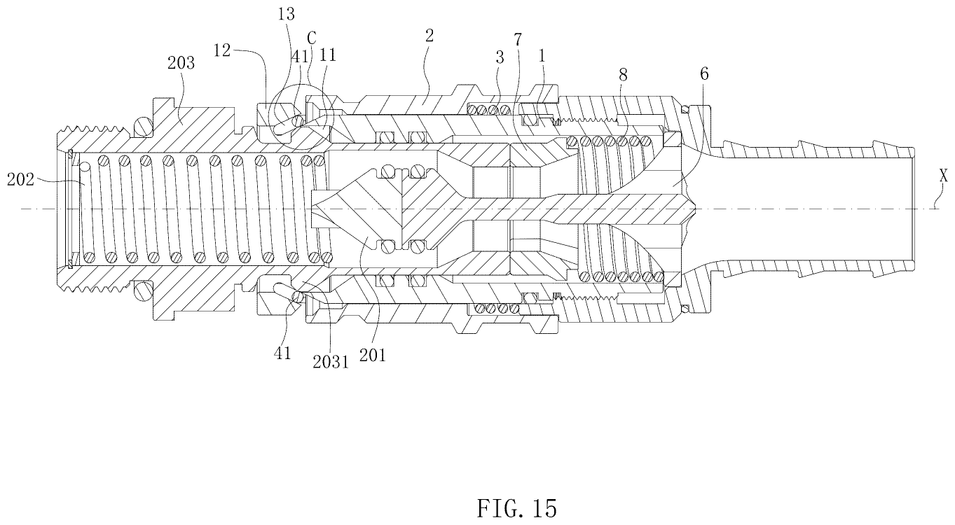

As shown in FIG. 13 to FIG. 14, the mating process of the plug 200 and the socket 100 continues, and in the process of the oblique surface M of the protrusion 2031 pushing the locking member 5 to move away from the central axis X along the corresponding one of the accommodating slot 14, the pushing portion 41 is located on the top surface P of the protrusion 2031, and the sliding shell 2 stops moving in the front-rear direction. The groove 23 is located in the moving direction of the locking member 5, and both the first circumferential surface 231 and the first annular oblique surface 232 maintain gaps with the locking member 5. As shown in FIG. 15 to FIG. 16, when the locking member 5 is located at the rear portion of the top surface P of the protrusion 2031, the pushing portion 41 is located at the front portion of the top surface P of the protrusion 2031, and the locking member 5 is accommodated in the groove 23.

In sum, the electrical connector according to the present invention has the following beneficial effects.

1. The driving members 4 at the front and the locking members 5 at the rear are provided. Each driving member 4 includes a pushing portion 41 and two limiting portions 42 integrally connected to the two ends of the pushing portion 42. The pushing portion 41 moves backward and away from the central axis of the shell 1 along the guiding slots 13. The limiting portions 42 push the abutting portions 26 backward, thereby driving the sliding shell 2 to move backward. Compared to case in the prior art where the front-row steel balls move radially, which is perpendicular to the direction of pushing the connecting nut, in the present invention, an angle between the moving direction of the pushing portion 41 and the backward pushing direction of the abutting portion 26 is less than 90 degrees, which results in minimal thrust dispersion, making it easier to push the sliding shell 2 backward. In addition, the backward travel of the pushing portion 41 is long, allowing the limiting portions 42 to drive the sliding shell 2 to move backward over a longer travel distance, which is conducive for the locking members 5 to move away from the central axis X of the shell 1 along the accommodating slots, such that in the mating process of the plug and the socket, the sliding shell automatically retracts backward, and the plug and the socket are easily locked.

2. By moving the pushing portion 41 toward the central axis X along the corresponding one of the guiding slots 13, the pushing portion 41 abuts against and is stopped by the front wall 131 of the guiding slot 13, thereby ensuring that the sliding shell 2 is stopped by the shell 1.

3. Each limiting portion 42 includes a first section 421 connected to the pushing portion 41 and a second section 422 bending and extending backward from the first section 421. The end of the second section 422 away from the first section 421 is fixed in the limiting slot 25 and abuts backward against the abutting portion 26. The end of the second section 422 away from the first section 421 provides the function of abutting backward against the abutting portion 26 and the function to be fixed in the limiting slot 25, which is conducive for the limiting portion 42 to stably abut against the sliding shell 2, without easily detaching from the sliding shell 2.

4. The buckling section 4222 of the limiting portion 42 needs to bend and extend and then be fixed into the fixing slot 251, and in the fixing process, the bending portion may interfere with the body 22. The limiting slot 25 is provided with a reserved slot 252 outside the fixing slot 251 to effectively prevent the interference between the buckling section 4222 and the body 22, which is conducive for the buckling section 4222 to be fixed in the fixing slot 251 and to abut backward against the abutting portion 26.

5. A gap exists between the end of the limiting portion 42 connected to the pushing portion 41 and the front surface 221 of the body 22, thus preventing the body 22 from interfering with the end of the limiting portion 42 connected to the pushing portion 41, and preventing the end of the limiting portion 42 connected to the pushing portion 41 from moving away from the central axis X and jamming using the end of the limiting portion 42 away from the pushing portion 41 as a pivotal point.

6. The impurities may easily enter the mounting cavity 21 from the front surface 221 of the body 22. Thus, the second circumferential surface 121 is sleeved inside the first circumferential surface 231, and the radial distance D1 between the second circumferential surface 121 and the first circumferential surface 231 is less than the radial distance D2 between the second circumferential surface 121 and the stopping portion 24, thus effectively reducing the gap between the sliding shell 2 and the shell 1, and preventing the impurities from entering and getting stuck therein.

7. The central distance L1 between the pushing portion 41 and the locking member 5 in the front-rear direction is less than or equal to the length L2 of the top surface P of the protrusion 2031, ensuring that when the locking member 5 is at the rear portion of the top surface P of the protrusion 2031, the pushing portion 41 is at the front portion of the top surface P of the protrusion 2031, such that in the process of the locking member 5 moving from the oblique surface M to the top surface P of the protrusion 2031, the driving member 4 maintains abutting against the sliding shell 2, preventing the sliding shell 2 from returning forward. The groove 23 is located in the moving direction of the locking member 5. The first circumferential surface 231 and the first annular oblique surface 232 maintain gaps with the locking member 5, ensuring that in the process of the oblique surface M of the protrusion 2031 pushing the locking member 5 to move away from the central axis X along the corresponding one of the accommodating slots 14, the locking member 5 may smoothly enter the groove 23 without the need to push the sliding shell 2 to move backward, thus reducing the resistance force and jamming.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A socket configured to mate with a plug, the plug comprising a protrusion and a locking slot, the protrusion comprising an oblique surface and a top surface connected to the oblique surface, the socket comprising:
a shell, wherein the shell defines a central axis mating with the plug, the shell includes an insertion cavity, a peripheral wall surrounding the insertion cavity, at least two guiding slots and a plurality of accommodating slots, the insertion cavity allows the plug to be inserted backward therein, each of the guiding slots and each of the accommodating slots run through the peripheral wall, the locking slot is located in front of the top surface, and the top surface is located in front of the oblique surface;
a sliding shell, sleeved outside of the shell, wherein the sliding shell includes a plurality of abutting portions, a stopping portion and a groove located in front of the stopping portion;
at least two driving members, wherein each of the driving members includes a pushing portion and two limiting portions integrally connected to two ends of the pushing portion, the pushing portion is accommodated in one of the two guiding slots, and the two limiting portions are located outside a same one of the guiding slots and in front of the two abutting portions; and
a plurality of locking members, correspondingly accommodated in the accommodating slots respectively, wherein each of the locking members is located behind the pushing portion of each of the driving members;
wherein prior to mating of the plug and the socket, the stopping portion abuts against the locking members, and the groove is located in front of the locking members;
wherein during a mating process of the plug and the socket, the protrusion moves backward, the oblique surface abuts against the pushing portion, the pushing portion moves backward along the corresponding one of the guiding slots and away from the central axis, and each of the limiting portions pushes each of the abutting portions backward to drive the sliding shell to move backward until the pushing portion reaches the top surface of the protrusion, and at this time, the locking members are located in front of the stopping portion;
wherein the protrusion continues to move backward, the oblique surface abuts against the locking members; the oblique surface pushes the locking members to move away from the central axis along the accommodating slots until the locking members reach the top surface of the protrusion, and at this time, the locking members are at least partially located within the groove;
wherein the protrusion continues to move backward, the locking members are at least partially located within the locking slot, and at this time, the sliding shell returns forward and each of the abutting portions pushes each of the limiting portions forward, the pushing portion moves toward the central axis along the corresponding one of the guiding slots, the groove is located in front of the locking members, and the stopping portion abuts against the locking members in the locking slots to achieve locking.

2. The socket according to claim 1, further comprising an elastic member sleeved outside of the shell, wherein each of the guiding slots includes a front wall near the central axis, in a forward returning process of the sliding shell, the elastic member pushes the sliding shell to move forward, the pushing portion moves toward the central axis along the corresponding one of the guiding slots, the pushing portion abuts against and is stopped by the front wall, and at this time, the abutting portions is stopped by the limiting portions.

3. The socket according to claim 1, wherein the sliding shell further includes a mounting cavity, a body surrounding the mounting cavity and a plurality of limiting slots concavely provided on an outer peripheral surface of the body, the abutting portions are rear walls of the limiting slots, the shell is accommodated in the mounting cavity, each of the limiting portions includes a first section connected to the pushing portion and a second section bending and extending backward from the first section, and an end of the second section away from the first section is fixed in a corresponding one of the limiting slots and abuts backward against a corresponding one of the abutting portions.

4. The socket according to claim 3, wherein each of the limiting slots includes a fixing slot and a reserved slot located outside the fixing slot, the second section of each of the limiting portions includes an extending section connected to the first section and a buckling section extending from the extending section, the two buckling sections of a same one of the driving members bend and extend toward each other, the buckling section passes through the reserved slot to be fixed in the fixing slot, a gap exists between the buckling section and a slot wall of the reserved slot, the abutting portions are rear walls of the fixing slots of the limiting portions, and the buckling section abuts backward against the corresponding one of the abutting portions.

5. The socket according to claim 3, wherein the pushing portion is located in front of the body, a gap exists between the first section and a front surface of the body, in the mating process of the plug and the socket, an end of the second section away from the first section serves as a pivotal point, the first section moves away from the central axis, the pushing portion moves away from the central axis along the corresponding one of the guiding slots, the sliding shell returns forward, the end of the second section away from the first section serves as the pivotal point, the first section moves toward the central axis, and the pushing portion moves toward the central axis along the corresponding one of the guiding slots.

6. The socket according to claim 1, wherein the sliding shell further includes a mounting cavity and a body surrounding the mounting cavity, the shell is accommodated in the mounting cavity, the groove is concavely provided on an inner peripheral surface of the body, the groove includes a first circumferential surface and a first annular oblique surface connected forward to the first circumferential surface, the first circumferential surface is connected to a front surface of the body, the first annular oblique surface inclines backward toward the central axis, an outer peripheral surface of the peripheral wall includes a second circumferential surface and a second annular oblique surface connected forward to the second circumferential surface; the second annular oblique surface inclines backward toward the central axis, and in a forward returning process of the sliding shell, the second annular oblique surface is located directly in front of the first annular oblique surface to stop the first annular oblique surface from excessively moving forward.

7. The socket according to claim 1, wherein the sliding shell further includes a mounting cavity and a body surrounding the mounting cavity, the shell is accommodated in the mounting cavity, the groove is concavely provided on an inner peripheral surface of the body, the groove includes a first circumferential surface and a first annular oblique surface connected forward to the first circumferential surface, the first circumferential surface is connected to a front surface of the body, the first annular oblique surface inclines backward toward the central axis and is connected backward to the stopping portion, the outer peripheral surface of the peripheral wall includes a second circumferential surface, the second circumferential surface is sleeved inside the first circumferential surface, and a first radial distance between the second circumferential surface and the first circumferential surface is less than a second radial distance between the second circumferential surface and the stopping portion.

8. The socket according to claim 1, wherein the sliding shell further includes a mounting cavity and a body surrounding the mounting cavity, the shell is accommodated in the mounting cavity, the groove is concavely provided on an inner peripheral surface of the body, the groove includes a first circumferential surface and a first annular oblique surface connected forward to the first circumferential surface, a distance from the pushing portion to a corresponding one of the locking members in a front-rear direction is less than or equal to a length of the top surface of the protrusion, in a process of the oblique surface of the protrusion pushing the corresponding one of the locking members to move away from the central axis along the corresponding one of the accommodating slots, the pushing portion is located on the top surface of the protrusion, the sliding shell stops moving in the front-rear direction, the groove is located in a moving direction of the locking members, both the first circumferential surface and the first annular oblique surface maintain gaps with the locking member, and when the locking members are located at a rear portion of the top surface of the protrusion, the pushing portion is located at a front portion of the top surface of the protrusion, and the locking members are accommodated in the groove.
